(19) United States
(12) Patent Application Publication
(10) Pub. No.: US 2003/0095690 A1
(43) Pub. Date: May 22, 2003

(54) Wireless fingerprint identity apparatus and method

(75) Inventors: Ching-Jun Su, Taipei (TW); Chu-Chia Tsai, Taipei (TW); Shih-Chin Lai, Taipei (TW)

Correspondence Address: Richard P. Berg, Esq., c/o LADAS & PARRY, Suite 2100, 5670 Wilshire Boulevard, Los Angeles, CA, 90036-5679, US

(73) Assignee: Acer Inc.

(21) Appl. No.: 10/052,755

(22) Filed: Jan. 18, 2002

(30) Foreign Application Priority Data
Nov. 16, 2001 (TW) 90128526

(51) Int. Cl. G06K 9/00

(52) U.S. Cl. 382/124

(57) ABSTRACT

A wireless fingerprint identity apparatus and method for electronic system security. The apparatus includes an identity device, a receiver module, and a fingerprint identification module. The identity device has a radio frequency (RF) module, which is able to transmit fingerprint data, gathered by a fingerprint image sensor, by a wireless transmission protocol. The fingerprint identification module is coupled to the receiver module and a memory module to save predetermined fingerprint data, wherein the fingerprint identification module differentiates the fingerprint data received by the receiver module, from predetermined fingerprint data and controls the electronic system accordingly.

### BACKGROUND OF THE INVENTION

1. Field of the Invention

The present invention relates to a fingerprint identity apparatus and method for an electronic system. In particular, the present invention relates to a fingerprint identity apparatus and method for an electronic system using wireless transmission.

2. Description of the Related Art

Before operating an electronic system containing valuable or secret information, a user frequently is required to input a preset user identity code and password, which limit access to the system and maintain system security. If the preset user identity code and password are divulged, this system presents very real security issues. Recently, a popular method uses an individual IC card and password to increase the system security, but it is still not safe enough.

Because everyone has unique fingerprints, fingerprint identification technique is widely employed in system security. In FIG. 1, an external fingerprint identity device (13) is connected to a desktop personal computer (11) by a cable (14), and a fingerprint image sensor module (12) is used to gather users' fingerprint data for the identification process through dedicated software and hardware.

FIG. 2 is a flow diagram of the external fingerprint identity process in FIG. 1. A user or a system manager sets predetermined fingerprint data by software and saves it in computer (11) to form a database (S201). To use the computer (11) (S202), the user must connect the external fingerprint identity apparatus (13) by the cable (14) and place a finger on the fingerprint image sensor (12) (S203). After transmitting the fingerprint data to the computer (11), the computer (11) differentiates the fingerprint data gathered by the fingerprint image sensor (12) (S204). When the fingerprint data matches the predetermined fingerprint data saved in database, the computer (11) enables access (S205). When the fingerprint data does not match the predetermined fingerprint data, the computer (11) disables access or shuts down (S206). Adopting the external fingerprint identity apparatus (13) is much safer, however, it is still inconvenient for businessmen to carry or use it with mobile electronic systems such as notebook computers (NB) or personal digital assistants (PDA).

### SUMMARY OF THE INVENTION

Accordingly, an object of the present invention is to provide a wireless fingerprint identity apparatus including an identity device, which transmits fingerprint data to a receiver by wireless transmission, to control access to the electronic system.

To achieve the aforementioned object, the present invention provides a fingerprint identity apparatus, comprising an identity device, a receiver module, and a fingerprint identification module, for an electronic system. The identity device has a fingerprint image sensor module coupled to an RF module, wherein the RF module transmits fingerprint data, gathered by the fingerprint image sensor, to the receiver module by a wireless transmission protocol. The fingerprint identification module is coupled to the receiver module and a memory module to save predetermined fingerprint data, wherein the fingerprint identification module is able to differentiate the fingerprint data, received by the receiver module, from the predetermined fingerprint data and control the electronic system accordingly.

Furthermore, the present invention provides an identity recognition method for a wireless identity apparatus of electronic system, including the steps of setting up predetermined fingerprint data, sensing fingerprint data, differentiating the fingerprint data from the predetermined fingerprint data, and then transmitting a first control signal by a wireless transmission protocol when the fingerprint data matches the predetermined fingerprint data, wherein the control signal is used to control the electronic system accordingly.

The present invention also provides another identity recognition method for a wireless identity apparatus of an electronic system, including the steps of setting up predetermined fingerprint data, sensing fingerprint data, transmitting the fingerprint data by a wireless transmission protocol, differentiating the fingerprint data from the predetermined fingerprint data, and then transmitting a first control signal when the fingerprint data matches the predetermined fingerprint data, wherein the control signal is used to control the electronic system accordingly.

### BRIEF DESCRIPTION OF THE DRAWINGS

These and other features, aspects, and advantages of the present invention will become better understood with reference to the following description, appended claims and accompanying diagrams where:

FIG. 1 (prior art) is a schematic structural diagram of an external fingerprint identity apparatus;

FIG. 2 (prior art) is a flow diagram of the external fingerprint identity process in FIG. 1.

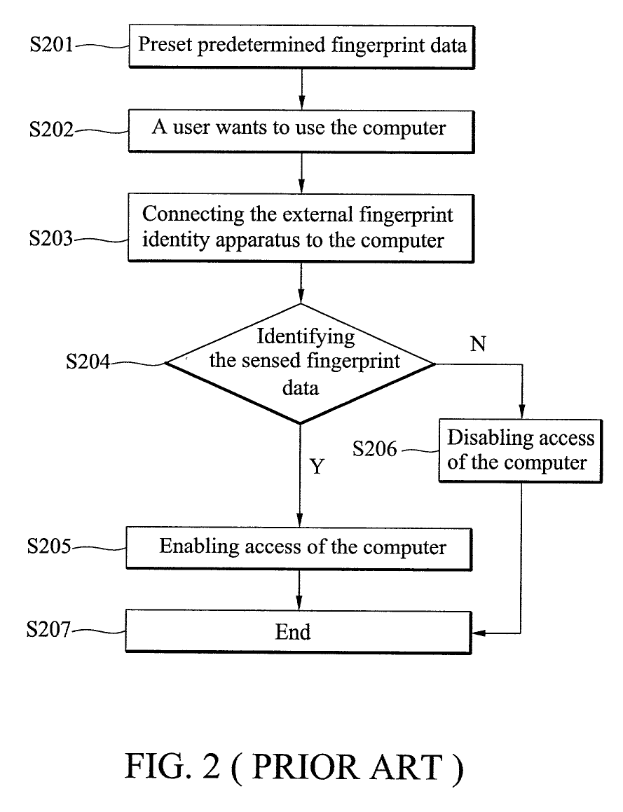

FIG. 3 is a schematic structural diagram of a notebook computer with a wireless fingerprint identity apparatus of the present invention;

FIG. 4A is a block diagram of a notebook computer with the wireless fingerprint identity apparatus of the first embodiment;

FIG. 4B is a flow diagram of the notebook computer with the wireless fingerprint identity apparatus in FIG. 4A;

FIG. 5A is a block diagram of a notebook computer with the wireless fingerprint identity apparatus of the second embodiment;

FIG. 5B is another block diagram of a notebook computer with the wireless fingerprint identity apparatus of the second embodiment;

FIG. 5C is a flow diagram of the notebook computer with the wireless fingerprint identity apparatus in FIG. 5A and FIG. 5B;

FIG. 6A is a block diagram of a notebook computer with the wireless fingerprint identity apparatus of the third embodiment; and

FIG. 6B is a flow diagram of the notebook computer with the wireless fingerprint identity apparatus in FIG. 6A.

### DETAILED DESCRIPTION OF THE INVENTION

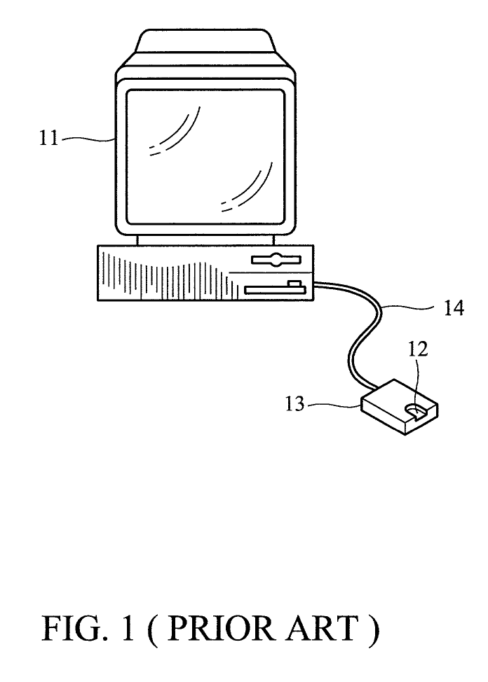

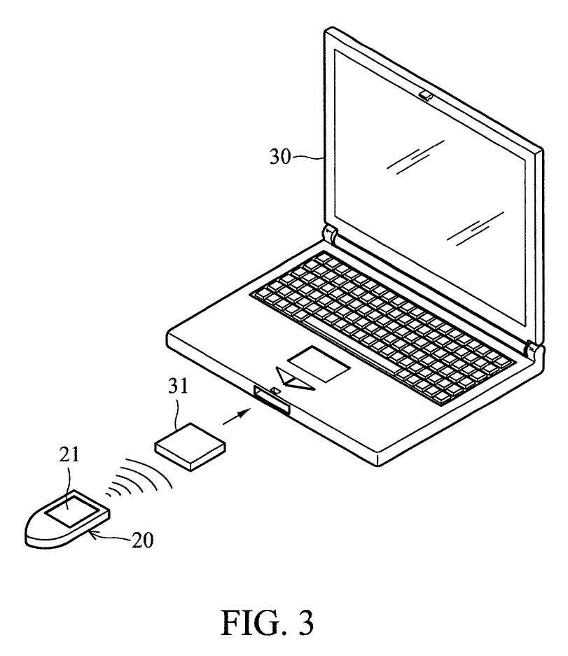

FIG. 3 is a schematic structural diagram of a notebook computer with a wireless fingerprint identity apparatus of the present invention. Compared with the external fingerprint identity apparatus (13) in FIG. 1, data gathered by wireless fingerprint identity apparatus is transmitted by radio waves instead of a cable (14).

Because the wireless fingerprint identity apparatus of the present invention transmits data and completes the fingerprint identification process by wireless transmission, a user does not need to connect an external fingerprint identity apparatus (13) to a computer (11), as shown in FIG. 1. To use the notebook computer (30) in FIG. 3, a user puts a finger on the fingerprint image sensor module (21) of the identity device (20) and completes the fingerprint identification process. The identity device (20) can be combined with personal items, such as a key ring, to avoid users forgetting or losing the identity device (20).

First Embodiment

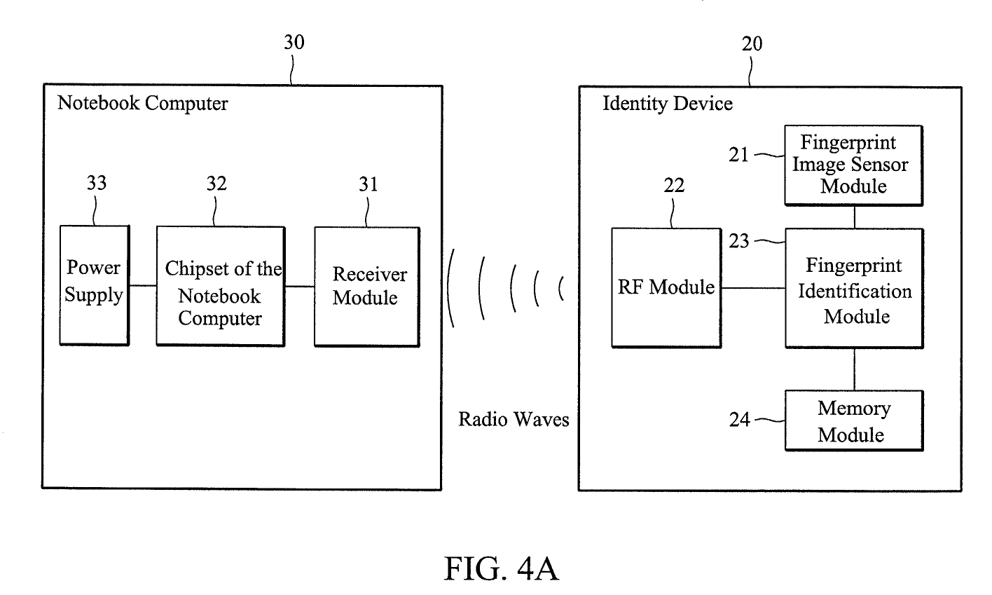

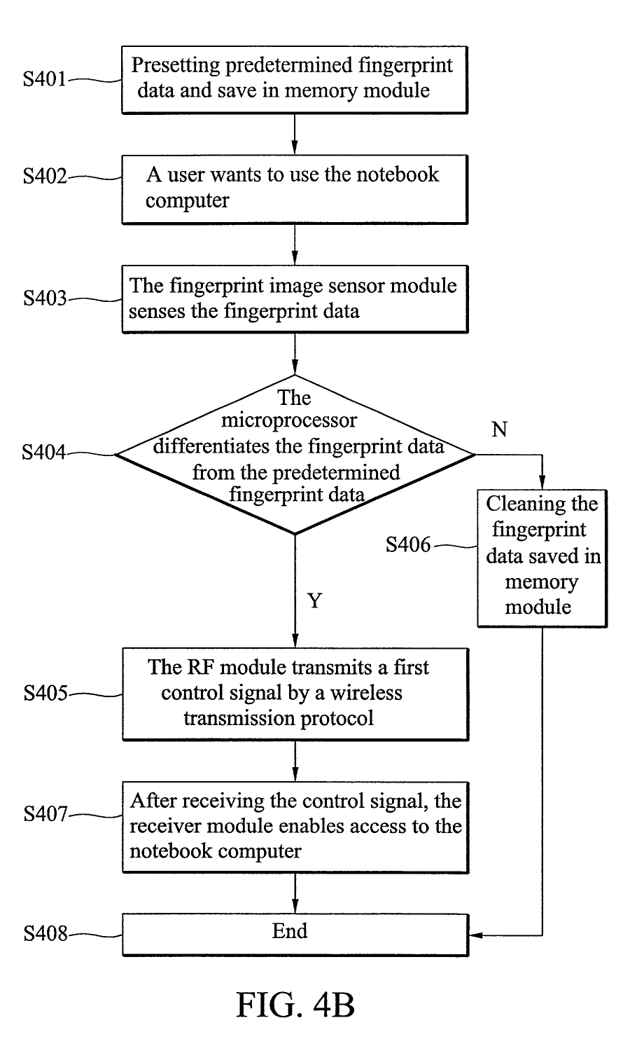

FIG. 4A is a block diagram of a notebook computer with the wireless fingerprint identity apparatus of the first embodiment. The wireless fingerprint identity apparatus in FIG. 4A is used for a notebook computer, desktop computer, or other related electronic systems. The wireless fingerprint identity apparatus comprises an identity device (20) having a fingerprint identification module (23) coupled to an RF module (22), a fingerprint image sensor module (21), and a memory module (24) to save predetermined fingerprint data, wherein the fingerprint identification module (23) is a microprocessor, the memory module (24) is Electrically Erasable Programmable Read-only Memory (EEPROM) or Flash Memory. When the fingerprint identification module (23) verifies that fingerprint data gathered by the fingerprint image sensor module (21) matches the predetermined fingerprint data, the RF module (22) transmits a control signal by a wireless transmission protocol, whose effective range is 10 meters for maximum system security.

The wireless fingerprint identity apparatus of this embodiment also has a receiver module (31), which receives the control signal transmitted by wireless transmission. After receiving the control signal, the receiver module (31) gives the chipset (32), or Southbridge and Northbridge, of the notebook computer (30) a dedicated command to turn on/off the power supply (33) of the notebook computer (30), or enable/disable access to the notebook computer (30).

FIG. 4B is a flow diagram of a notebook computer with the wireless fingerprint identity apparatus of the first embodiment. The wireless identity recognition method in FIG. 4B is used for the wireless fingerprint identity apparatus of this embodiment in FIG. 4A. First, a user or a system manager initializes the identity device (20) and presets predetermined fingerprint data, which is saved in the memory module (24), such as EEPROM or Flash Memory, of the identity device (20) (S401). When using the notebook computer (30), a user puts a finger on the fingerprint image sensor module (21) (S402). After the fingerprint image sensor module (21) gathers the fingerprint data (S403), the fingerprint identification module (23), or a microprocessor, differentiates the fingerprint data from the predetermined fingerprint data (S404). When the fingerprint data matches the predetermined fingerprint data, the RF module (22) transmits a first control signal by wireless transmission (S405). After receiving the control signal transmitted by wireless transmission, the receiver module (31) gives the chipset (32), or Southbridge and Northbridge, of the notebook computer (30) a dedicated command to turn on the power supply (33) of the notebook computer (30), or enable access to the notebook computer (30) (S407).

When the fingerprint data does not match the predetermined fingerprint data, the RF module (22) transmits a second control signal by wireless transmission to turn off the power supply (33) or disable access to the notebook computer (30), and clear the fingerprint data saved in memory module (24) (S406).

Second Embodiment

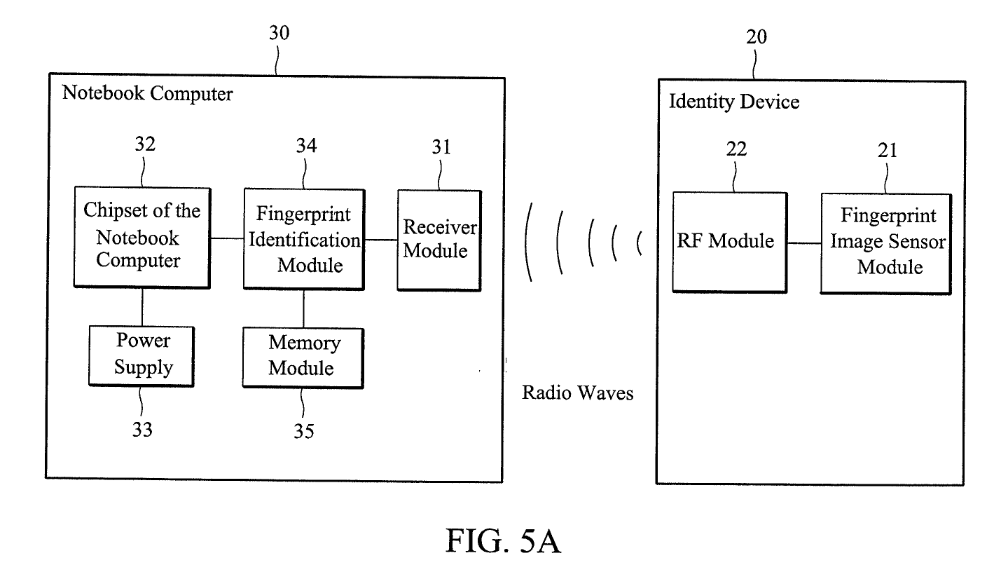

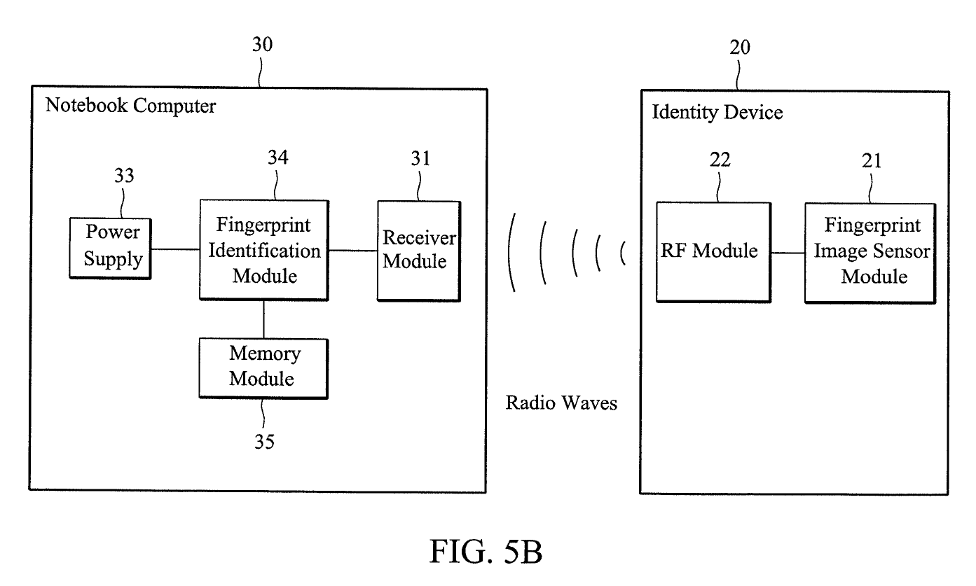

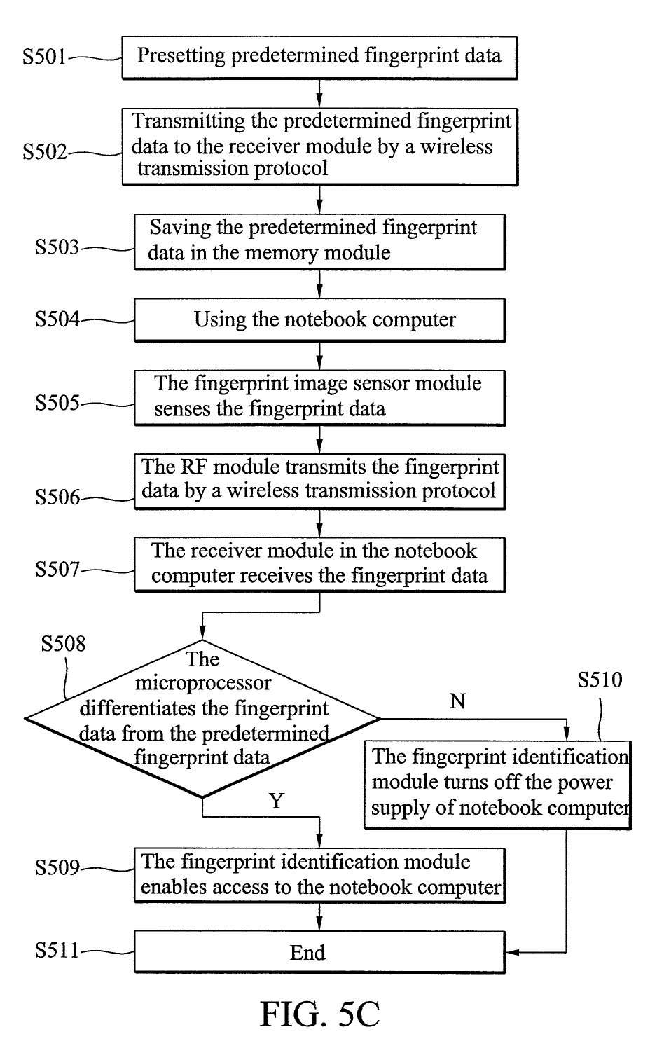

The present invention provides another fingerprint identity apparatus for an electronic system. FIG. 5A is a block diagram of a notebook computer with the wireless fingerprint identity apparatus of the second embodiment. The wireless fingerprint identity apparatus in FIG. 5A is used for a notebook computer, desktop computer, or other related electronic systems. The wireless fingerprint identity apparatus comprises an identity device (20) having a fingerprint image sensor module (21) coupled to an RF module (22), wherein the RF module (22) transmits fingerprint data, gathered by the fingerprint image sensor (21), by a wireless transmission protocol, whose effective range is 10 meters for maximum system security.

The wireless fingerprint identity apparatus of this embodiment also has a receiver module (31), which receives fingerprint data transmitted by wireless transmission from the identity device (20). The fingerprint identification module (34) inside the notebook computer (30) is a microprocessor and coupled to the receiver module (31), a memory module (35), and the chipset (32) of notebook computer (30), wherein the fingerprint identification module (34) is designed as a module separately or specialized circuit on main board, and the memory module is EEPROM or Flash Memory to save predetermined fingerprint data. When the fingerprint data received by the receiver module (31) matches the predetermined data, the fingerprint identification module (34) enables access to the notebook computer (30). When the fingerprint data does not match the predetermined data, the fingerprint identification module (34) turns off the notebook computer (30).

Referring to FIG. 5A, the fingerprint identification module (34) is coupled to the chipset (32), or Southbridge and Northbridge, of notebook computer (30). According to the result of fingerprint recognition, the fingerprint identification module (34) sends different control signals to the chipset (32) to turn on/off the power supply (33) of the notebook computer (30), lock the mouse or keyboard of the notebook computer (30), or enable/disable access to the notebook computer (30).

FIG. 5B is another structure of this embodiment. In FIG. 5B, the fingerprint identification module (34) is directly coupled to the power supply (33) of notebook computer (30). According to the result of fingerprint recognition, the fingerprint identification module (34) directly controls the power supply (33) to turn on/off the notebook computer (30).

FIG. 5C is a flow diagram of the notebook computer with the wireless fingerprint identity apparatus in FIG. 5A and FIG. 5B. First, a user or a system manager initializes the identity device (20) and presets predetermined fingerprint data, which is gathered by the fingerprint image sensor (21) (S501), transmitted by the RF module (22) (S502), and saved in the memory module (24) (S503). When using the notebook computer (30), a user puts a finger on the fingerprint image sensor module (21) (S504). The fingerprint image sensor module (21) gathers the fingerprint data (S505) and the RF module (22) transmits the fingerprint data by wireless transmission (S506). After the receiver module (31) in the notebook computer (30) receives the fingerprint data (S507), the fingerprint identification module (34), or a microprocessor, differentiates the fingerprint data from the predetermined fingerprint data (S508). When the fingerprint data matches the predetermined fingerprint data, the fingerprint identification module (34) controls the notebook computer (30) by dedicated command to turn on the power supply (33), or enable access to the notebook computer (30) (S509). When the fingerprint data does not match the predetermined fingerprint data, the fingerprint identification module (34) turns off the power supply (33), disables access to the notebook computer (30), locks the keyboard, or deletes data saved in hard disk (S510).

Third Embodiment

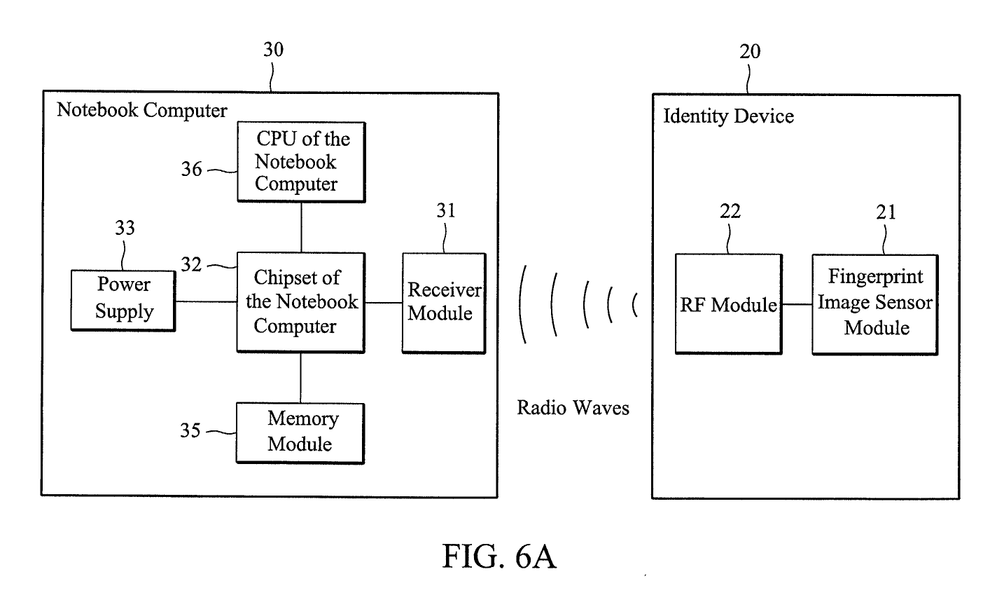

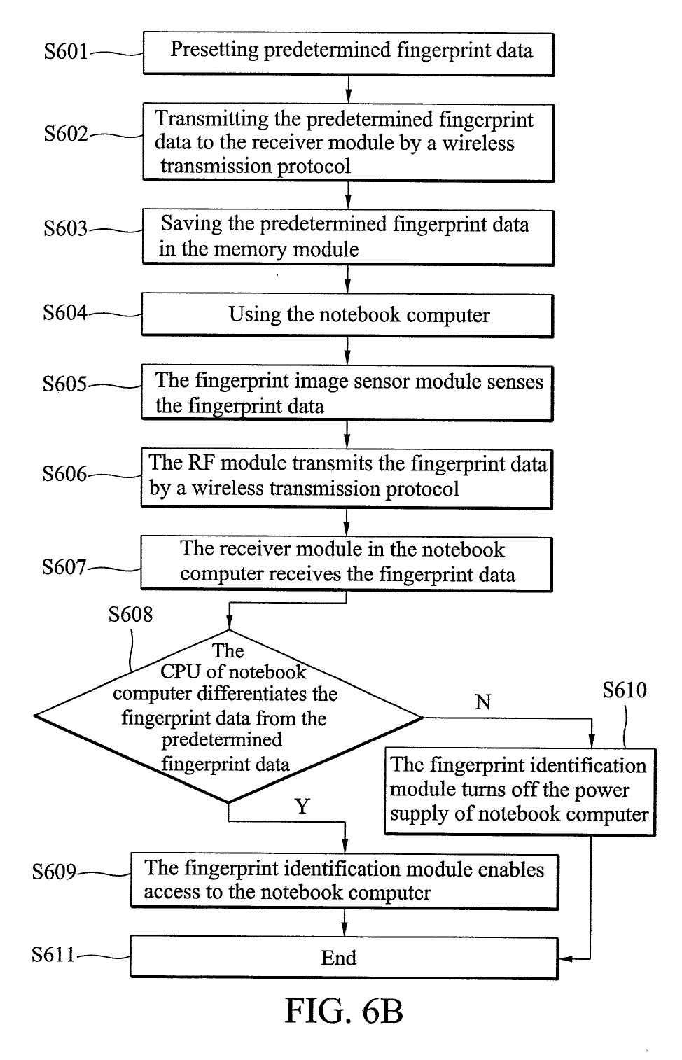

The present invention provides another fingerprint identity apparatus for an electronic system. FIG. 6A is a block diagram of a notebook computer with the wireless fingerprint identity apparatus of third embodiment. The wireless fingerprint identity apparatus in FIG. 6A is used for a notebook computer, desktop computer, or other related electronic systems. The wireless fingerprint identity apparatus comprises an identity device (20), having a fingerprint image sensor module (21) coupled to an RF module (22), wherein the RF module (22) transmits fingerprint data, gathered by the fingerprint image sensor (21), by a wireless transmission protocol, whose effective range is 10 meters for maximum system security.

The wireless fingerprint identity apparatus of this embodiment also has a receiver module (31), which receives fingerprint data transmitted by wireless transmission from the identity device (20).

In FIG. 6A, in order to reduce cost, the CPU (36) and chipset (32) of notebook computer (30) perform the identification process instead of an additional microprocessor in the notebook computer (30). The chipset (32) of notebook computer (30) is coupled to the receiver module (31), a memory module (35), a power supply (33), and the CPU (36) of notebook computer (30), wherein the chipset (32) is Southbridge and Northbridge, the memory module is EEPROM on main board of notebook computer (30) or an additional memory, such as Flash Memory, to save predetermined fingerprint data.

Furthermore, at the moment of the notebook computer (30) receiving the “Power On” signal from identity device (20), the power supply (33) is turned on and the receiver module (31) receives the fingerprint data continuously. The CPU (36) of notebook computer (30) differentiates the fingerprint data from the predetermined fingerprint data saved in the memory module (35). When the fingerprint data matches the predetermined data, the CPU (36) enables access to the notebook computer (30) through Southbridge and Northbridge, such as enabling the mouse or keyboard. When the fingerprint data does not match the predetermined data, the CPU (36) turns off the power supply (33) notebook computer (30) through Southbridge and Northbridge.

FIG. 6B is a flow diagram of a notebook computer with the wireless fingerprint identity apparatus in FIG. 6A. First, a user or system manager initializes the identity device (20) and presets predetermined fingerprint data, which is gathered by the fingerprint image sensor (21) (S601), transmitted by the RF module (22) (S602), and saved in the memory module (24) (S603). When using the notebook computer (30), a user puts a finger on the fingerprint image sensor module (21) (S604). The fingerprint image sensor module (21) gathers the fingerprint data (S605). The RF module (22) transmits the fingerprint data by wireless transmission (S606). After the receiver module (31) in the notebook computer (30) receives the control signal (S607), the power supply (33) is turned on immediately. According to the BIOS of the notebook computer (30), the chipset (32) controls the CPU (36) to differentiate the fingerprint data received by the receiver module (31) from the predetermined fingerprint data saved in the memory module (35) (S608). When the fingerprint data matches the predetermined fingerprint data, the CPU (36) controls the notebook computer (30) through Southbridge and Northbridge by dedicated command to enable access to the notebook computer (30) (S609). When the fingerprint data does not match the predetermined fingerprint data, the CPU directs the notebook computer (30) to turn off the notebook computer (30), disable access to the notebook computer (30), lock the keyboard, or delete data saved in hard disk (S610).

It is to be understood that the present invention is not limited to the embodiments described above, but encompasses any and all embodiments within the scope of the following claims.

What is claimed is:

1. A fingerprint identity apparatus for an electronic system, comprising:
an identity device, having a fingerprint image sensor module coupled to a radio frequency (RF) module, wherein the RF module transmits fingerprint data, gathered by the fingerprint image sensor, by a wireless transmission protocol;
a receiver module, receiving the fingerprint data transmitted by wireless transmission; and
a fingerprint identification module, coupled to the receiver module and a memory module to save predetermined fingerprint data, wherein the fingerprint identification module differentiates the fingerprint data, received by the receiver module, from the predetermined fingerprint data and controls the electronic system accordingly.

2. The fingerprint identity apparatus as claimed in claim 1, wherein the fingerprint identification module is a microprocessor.

3. The fingerprint identity apparatus as claimed in claim 1, wherein when the fingerprint data matches the predetermined fingerprint data, the fingerprint identification module enables access to the electronic system.

4. The fingerprint identity apparatus as claimed in claim 1, wherein when the fingerprint data does not match the predetermined fingerprint data, the fingerprint identification module disables access to the electronic system.

5. The fingerprint identity apparatus as claimed in claim 1, wherein when the fingerprint data does not match the predetermined fingerprint data, the fingerprint identification module turns off the electronic system.

6. The fingerprint identity apparatus as claimed in claim 1, wherein the electronic system is a notebook computer.

7. The fingerprint identity apparatus as claimed in claim 6, wherein a fingerprint identification module comprises a CPU and Chipset of a notebook computer.

8. A wireless identity recognition method for an electronic system, comprising the steps of:
setting up predetermined fingerprint data;
sensing fingerprint data;
differentiating the fingerprint data from the predetermined fingerprint data; and
transmitting a first control signal by a wireless transmission protocol when the fingerprint data matches the predetermined fingerprint data.

9. The wireless identity recognition method as claimed in claim 8, wherein the fingerprint identification module is a microprocessor.

10. The wireless identity recognition method as claimed in claim 8, wherein the first control signal is used to power up the electronic system.

11. The wireless identity recognition method as claimed in claim 8, wherein the first control signal is used to enable access to the electronic system.

12. The wireless identity recognition method as claimed in claim 8, also comprising the step of:
transmitting a second control signal by wireless transmission when the fingerprint data does not match the predetermined fingerprint data.

13. The wireless identity recognition method as claimed in claim 12, wherein the second control signal is used to turn off the electronic system.

14. The wireless identity recognition method as claimed in claim 12, wherein the first control signal is used to disable access to the electronic system.

15. A wireless identity recognition method for an electronic system, comprising the steps of:
setting up predetermined fingerprint data;
sensing fingerprint data;
transmitting the fingerprint data by a wireless transmission protocol; and
differentiating the fingerprint data from the predetermined fingerprint data;

16. The wireless identity recognition method as claimed in claim 15, also comprising the step of transmitting a first control signal when the fingerprint data matches the predetermined fingerprint data.

17. The wireless identity recognition method as claimed in claim 16, wherein the first control signal is used to enable access to the electronic system.

18. The wireless identity recognition method as claimed in claim 16, also comprising the step of:
transmitting a second control signal by wireless transmission when the fingerprint data does not match the predetermined fingerprint data.

19. The wireless identity recognition method as claimed in claim 18, wherein the second control signal is used to turn off the electronic system.

20. The wireless identity recognition method as claimed in claim 18, wherein the second control signal is used to disable access to the electronic system.
